(19) United States
(12) Patent Application Publication
(10) Pub. No.: US 2005/0125239 A1
(43) Pub. Date: Jun. 9, 2005

(54) System for managing quality of service measurement on a network

(76) Inventors: Olivier Martinot, Draveil (FR); Stephane Betge-Brezetz, Paris (FR); Emmanuel Marilly, Saint-Michel-Sur-Orge (FR); Gerard Delegue, Cachan (FR)

Correspondence Address: SUGHRUE MION, PLLC, 2100 PENNSYLVANIA AVENUE, N.W., SUITE 800, WASHINGTON, DC, 20037, US

(21) Appl. No.: 10/510,110

(22) PCT Filed: Mar. 14, 2003
(86) PCT No.: PCT/FR03/00818

(30) Foreign Application Priority Data
Apr. 5, 2002 (FR) 02/04272

(51) Int. Cl. G06F 17/60

(52) U.S. Cl. 705/1

(57) ABSTRACT

The invention concerns a system (9) for managing quality of service measurement on a network comprising means (3) for storing a set of logical quality of service rules defined by operators, mans (2) for instantiating the logical rules, said instantiation being carried out based on the service independently of the network technology, means (2) for determining measurement points independently of the network technology, means (4,5) for implementing the measurement points on the elements (8) of the network and means for collecting data obtained from the measurement points. Said system (9) is particularly adapted to control quality of service and to charging policies and can be integrated in a global service management system on a network.

The present invention relates to a system for managing measurement of the quality of service on a network, more particularly suited to monitoring the quality of service and billing for this service.

The expansion of applications on networks is leading to a necessary adaptation of resources such as bandwidth or transmission time of these networks as a function of the type of application used. Thus data streams linked to a telephony application are more sensitive to delay constraints than are electronic mail data streams. It is therefore proving more and more important to distinguish between applications in order to process them specifically. The distinction is effected by introducing the concept of quality of service (QoS). The QoS is the capacity of a network element such as a router to satisfy service and traffic requirements. The QoS therefore offers a customer a guarantee as to the quality of the service that he is purchasing from a provider: the performance constraints of the network elements assuring a particular QoS are set out in a contractual document known as the Service Level Agreement (SLA) entered into by the client and the service provider. Each SLA is associated with a set of network technical parameters, known as the Service Level Specification (SLS), said parameters defining how a service must be processed on a network to respect a particular QoS.

Moreover, network infrastructures are more and more complex and heterogeneous since they generally use a plurality of technologies such as the IP (Internet Protocol) and ATM (Asynchronous Transfer Mode) transmission modes.

In this context, the introduction of a great variety of services, each associated with an SLA contract, further complicates network management. This is because, as operators offer new services with very high added value, they also need to collect more and more pertinent information on the performance of those services: through the measurement of parameters, this information may be used both to monitor the QoS and to invoice the client accordingly.

As is known in the art, at present a limited number of performance parameters such as availability or bandwidth may be measured. Measurement points on the network elements are configured manually, which causes a certain number of problems.

This is because the heterogeneous nature and the complexity of the networks require highly skilled technical intervention teams to configure each type of network manually.

Furthermore, the multiplication of service offers requires that these teams be very large.

Moreover, the manual deployment of measurement points is extremely time-consuming.

The present invention aims to provide a system for managing the measurement of the quality of service on a network that circumvents problems stemming from manual configuration of the performance measuring points.

To this end the present invention proposes a system for managing the measurement of the quality of service on a network, characterized in that said system comprises:
means for storing a set of quality of service measurement logical rules defined by operators,
means for instantiating said logical rules, said instantiation being effected as a function of said service and independently of the technology of said network,
means for determining measurement points independently of the technology of said network,
means for implementing said measurement points on the elements of said network, and
means for collecting data obtained from said measurement points.

Thanks to the invention, pooling the expertise of operators in the form of pertinent logical rules for assessing quality of service avoids the problems arising from the increasing requirement for installation team size and expertise, all the expertise being pooled by way of means of input into the storage means.

Furthermore, the measurement points are deployed automatically via the implementation means when a new service is requested by a user. This automation leads to a major time saving.

The system for managing the measurement of the quality of service on a network advantageously comprises means for comparing said collected data with threshold values. These means enable an alarm to be triggered if a threshold value is exceeded, for example.

In one embodiment, the system according to the invention comprises means for entering quality of service measurement logical rules defined by operators.

The system according to the invention advantageously comprises means for entering technical parameters defining said service.

The present invention also proposes a service management system comprising a system in accordance with the invention for managing the measurement of quality of service.

Thus the quality of service measurement management system is integrated directly into the service management system and therefore obtains the benefit of the infrastructures of that management system without it being necessary to design infrastructures specific to the quality of service measurement management system.

The service management system advantageously comprises means for storing service policies, means for distributing said service policies, and means for applying said service policies to the elements of said network, said system being characterized in that:
said service policy storage means include said means for storing said set of measurement logical rules,
said means for distributing said service policies include said means for instantiating said measurement logical rules to monitor said service and said means for determining measurement points, and
said means for applying said service policies to the elements of said network include said means for implementing said measurement points on the elements of said network.

Other features and advantages of the present invention will become apparent in the course of the following description of one embodiment of the invention, given by way of illustrative and nonlimiting example.

In the appended drawings:

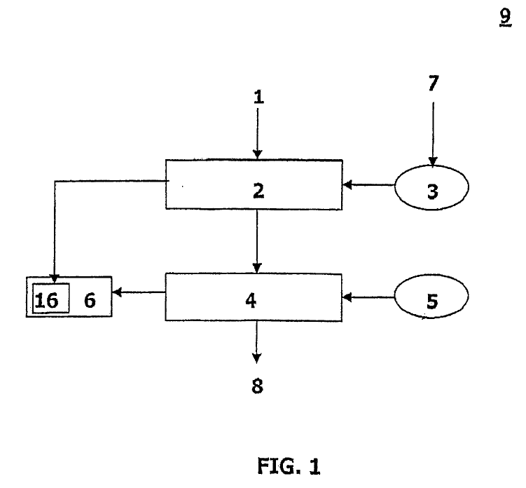

FIG. 1 represents diagrammatically the quality of service measurement management system of the invention,

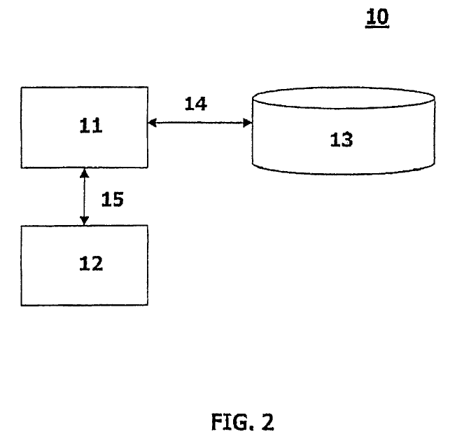

FIG. 2 represents a prior art service management system, and

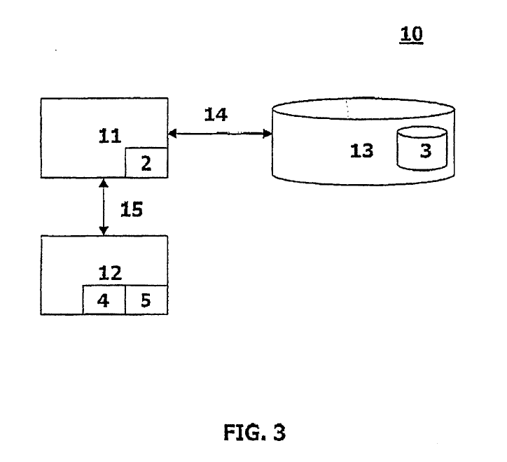

FIG. 3 represents a service management system of the invention.

Common items carry the same reference numbers in all the figures.

FIG. 1 shows diagrammatically a system 9 according to the invention. The system 9 includes means 1 for entering technical parameters defining or modifying a service, means 7 for entering quality of service measurement logical rules, means 3 for storing a set of quality of service measurement logical rules defined by operators, means 2 for instantiating logical rules and determining measurement points, means 4 and 5 for implementing said measurement points on the elements 8 of the network, and means 6 for collecting data obtained from measurement points incorporating means 16 for comparing said collected data with threshold values.

The operators use the means 7 in the means 3 to enter as comprehensively as possible the logical rules for pertinent measurement of the quality of a service. These rules are logical and therefore at a high level of abstraction, independent of the technology of the networks used.

When a user negotiates an SLA contract with a service provider, the contract defines technical parameters contained in an SLS. The technical parameters are entered via the means 1, either entirely by the operator as a function of the SLA contract or partly by the user via a web interface, for example.

As a function of the SLS parameters coming from the means 1, the means 2 search the means 3 for the logical rules necessary for setting up the measurement and determine from those rules the measurement points for setting up the quality of service measurement.

The means 4 then use the information supplied by the means 2 to implement the measurements to be effected physically, i.e. at the various physical elements 8 of the network. To this end, the means 4 also use physical rules depending on the network in which the measurements are effected; these physical rules are supplied by the means 5. The means 4 also supply the locations of the measurement points to the means 6 for collecting the measurements. The measurements are then collected in the means 6. The means 16 are then used to compare the values of the measurements collected as a function of threshold values supplied by the means 2 as a function of the SLS parameters. The means 16 may therefore trigger an alarm if the values of the measurements collected exceed the threshold values.

FIG. 2 represents a system 10 for managing services on a network. This type of system has already been described by the Internet Engineering Task Force (IETF). The system 10 includes a rules server 11 also known as a policy decision point (PDP), a device 12 known as a policy enforcement point (PEP), and a database 13 known as a policy repository (PR). The exchange of information between the server 11 and the database 13 is effected in accordance with a lightweight directory access protocol (LDAP) 14 and the exchange of information between the server 11 and the device 12 is effected in accordance with a common open policy service (COPS) protocol 15.

A user informs the device 11 of a requirement for or a modification of a service. Using the protocol 14, the server 11 searches the database 13 for the rule corresponding to that request, instantiates that rule, and determines the points at which the rule must be applied. The server 11 then returns a decision to the device 12 that is to implement the service physically on the network.

FIG. 3 represents a service management system 10 on a network such as that shown in FIG. 2 comprising means 3 for storing a set of measurement logical rules, means 2 for instantiating the logical rules and determining measurement points, and means 4 and 5 for implementing said measurement points on the network elements.

The database 13 includes the means 3, the server 11 includes the means 2, and the device 12 includes the means 4 and 5.

Accordingly, when a user subscribes to a new service, that service is implemented at the same time and using the same tools as the implementation of the measurement of the pertinent associated quality of service parameters.

Each SLS parameter may be divided into a series of object classes. These classes include, for example:
the period of validity of the service, i.e. the period of time for which the service is available;
the topology that defines the input and output ports; and
the profile of the data traffic, i.e. the characteristics of the traffic to respond to the requested quality of service (in particular the bandwidth).

To set up a service associated with an SLS parameter, the server 11 uses one or more rules associated with the “topology” class.

To set up the measurement, the means 2 also use logical rules associated with the topology class. The “validity period” class enables the means 2 to inform the measurement collection means 6 represented in FIG. 1 of the period during which the measurements must be effected. The “data traffic profile” class enables the means 2 to inform the means 16 of thresholds to be set up. Accordingly, in the event of failure to respect the quality of service, the measurement values will exceed the threshold values and trigger an alarm.

1. System (9) for managing the measurement of the quality of service on a network, characterized in that said system (9) comprises:
means (3) for storing a set of quality of service measurement logical rules defined by operators,
means (2) for instantiating said logical rules, said instantiation being effected as a function of said service and independently of the technology of said network,
means (2) for determining measurement points independently of the technology of said network,
means (4, 5) for implementing said measurement points on the elements of said network, and
means (6) for collecting data obtained from said measurement points.

2. System (9) according to claim 1 comprising means (16) for comparing said collected data with threshold values.

3. System (9) according to claim 1 comprising means (7) for entering quality of service measurement logical rules defined by operators.

4. System (9) according to claim 1 comprising means (1) for entering technical parameters defining said service.

5. System (10) for managing service on a network comprising a quality of service measurement management system (9) according to claim 1.

6. System (10) according to claim 5 comprising means (13) for storing service policies, means (11) for distributing said service policies, and means (12) for applying said service policies to the elements of said network, said system (10) being characterized in that:
said service policy storage means (13) include said means (3) for storing said set of measurement logical rules,
said means (11) for distributing said service policies include said means (2) for instantiating said measurement logical rules to monitor said service and said means (2) for determining measurement points, and
said means (12) for applying said service policies to the elements of said network include said means (4, 5) for implementing said measurement points on the elements of said network.
